(19) United States
(12) Patent Application Publication
(10) Pub. No.: US 2026/0120403 A1
(43) Pub. Date: Apr. 30, 2026

(54) METHOD, SYSTEM AND COMPUTER PROGRAM PRODUCT FOR FORMING A DIGITAL SURFACE MODEL BASED ON TREETOPS

(71) Applicant: SAAB AB, Linköping (SE)

(72) Inventors: Astrid LUNDMARK, Linköping (SE); Viktor RINGDAHL, Linköping (SE)

(21) Appl. No.: 18/704,651

(22) PCT Filed: Nov. 7, 2022
(86) PCT No.: PCT/SE2022/051027

§ 371 Date: Apr. 25, 2024

(30) Foreign Application Priority Data
Nov. 9, 2021 (SE) 2100172-2

(51) Int. Cl. G06T 17/05; G01C 5/00; G06T 7/73

(52) U.S. Cl. CPC G06T 17/05; G01C 5/005; G06T 7/74; G06T 7/75; G06T 2200/04; G06T 2207/10036; G06T 2207/10044; G06T 2207/20084; G06T 2207/30188

(57) ABSTRACT

The present disclosure relates to a computer implemented method for forming a digital surface model of treetops. The method (100) comprises the steps of obtaining (110) at least two images from a flying platform; detecting (130) treetops in each image; determining (140) a treetop position for each matching treetop detected in plurality of said at least two images; and forming (150) the digital surface model based on said at least one determined treetop position.

### TECHNICAL FIELD

The present disclosure relates to forming digital surface models based on treetops.

### BACKGROUND ART

GPS-free navigation and localization is of special interest for flying platforms. Some existing solutions are based on capturing photographs at a flying platform, determining an estimate of the surrounding terrain and comparing said estimate against known terrain data. Some existing solutions utilize a known 3D model of Earth's surface and attempt to find a perspective view in said 3D model corresponding to a captured photo.

A problem with existing solutions is that they do no provide an accurate digital surface model of Earth's surface for forested terrain.

### SUMMARY OF THE INVENTION

One objective of the invention is to improve digital surface models of forested terrain by forming digital surface models of treetops.

This has in accordance with the present disclosure been achieved by means of a computer implemented method for forming a digital surface model of treetops. The method comprises the steps of obtaining at least two images from a flying platform; detecting treetops in each image; determining a treetop position for each matching treetop detected in plurality of said at least two images; and forming the digital surface model based on said at least one determined treetop position.

This allows the treetops to define a convex hull of the digital surface model, DSM, whereby a more realistic DSM is formed. This further allows a real-time DSM to be produced and utilized for navigation, in contrast to a predetermined DSM which may contain outdated height data relating to trees. This further allows comparisons between the digital surface models formed at different points in time in order to determine the growth of trees in an area.

The term digital surface model, DSM, relates to a 3D computer graphics representation of elevation data representing terrain. Typically said represented terrain is a part of Earth's surface.

In some examples the method further comprises obtaining a neural network trained to detect treetops in images, wherein detecting treetops in each image comprises utilizing each image as an input image for said neural network, determining for each image a neural network output, and, if said output comprises at least one detected treetop, determining for each detected treetop a feature vector based on intermediate values calculated in the neural network while generating said output; and wherein determining the treetop position is based on said determined neural network outputs and corresponding at least one feature vector.

This has the advantage of significantly lowering computational cost as the neural network generates more easy to process neural network outputs and corresponding feature vectors for said images. This further has the advantage of allowing additional information relating to the detected treetops to be determined based on the feature vectors, such as type of tree.

In some examples of the method, determining the treetop position comprises comparing feature vectors corresponding to said determined neural network outputs, and wherein determining the treetop position is based on matching neural network outputs based on said comparison of feature vectors.

In some of these examples, comparing the feature vectors is based on utilizing Euclidian distance and/or cosine similarity and/or phase correlation.

This has the advantage of allowing similarities between feature vectors to be quantified and utilized to match detected treetops in order to determine treetop positions.

In some examples of the method, obtaining at least two images from a flying platform further comprises obtaining a set of relative differences in image capture position and/or pose corresponding to said at least two images, and wherein determining treetop position is further based on said set of relative differences in image capture position and/or pose.

This has the advantage of allowing an increased accuracy in determined treetop positions. This further has the advantage of allowing a decreased degree of freedom in matching detected treetops, thereby decreasing computational cost.

In some examples of the method, determining the treetop position for each matching treetop detected in a plurality of said at least two images comprises detecting and eliminating treetop position outliers.

In some examples of the method, obtaining at least two images from a flying platform further comprises obtaining a radar and/or a lidar altitude measurement and determining a height of said flying platform based on said altitude measurement, and wherein determining treetop position is further based on said determined height.

This has the advantage of allowing an increased accuracy in determined treetop positions. This further has the advantage of allowing determined treetop positions outliers at anomalous heights to be omitted, such as treetop positions below ground level or far above ground level.

In some examples of the method, comprises comparing the formed digital surface model with an obtained predetermined digital surface model, and determining a position and/or a pose of the flying platform based on said comparison between the formed digital surface model and the predetermined digital surface model, and/or forming an updated version of said obtained predetermined digital surface model based on the formed digital surface model.

This has the advantage of allowing a formed digital surface model to be compared with the larger predetermined digital surface model defined in relationship to a global coordinate system, thereby allowing any part of the predetermined digital surface model that corresponds to the formed digital surface model to be identified. Thereafter the formed digital surface model may be used to determine a position and/or a pose in said global coordinate system, or to form an updated version of the predetermined digital surface model with improved treetop representation.

The present disclosure further relates to a computer program product comprising a non-transitory computer-readable storage medium having thereon a computer program comprising program instructions, the computer program being loadable into a processor and configured to cause the processor to perform the previously disclosed method.

The present disclosure further relates to a system for forming a digital surface model of treetops, the system comprises a set of sensors arranged to capture images, and a computer arranged to communicate with the set of sensors. The computer is further arranged to obtain at least two images from the set of sensors; detect treetops in each image; determine a treetop position for each matching treetop detected in a plurality of said at least two images; and form the digital surface model based on said at least one determined treetop position.

In some examples of the system, the computer is arranged to detect treetops in each image using a neural network trained to detect treetops in images, determine for each image a neural network output, and determine for each of at least one part of said neural network output a feature vector based on intermediate values generated in the neural network during treetop detection of the corresponding image; and determine treetop position based on said determined neural network outputs and corresponding at least one feature vector.

This has the advantage of significantly lowering computational cost for the computer as the neural network generates more easy to process neural network outputs and corresponding feature vectors for said images.

In some examples, the system comprises a memory storage comprising at least one predetermined digital surface model, wherein the computer is arranged to communicate with the memory storage. The computer is further arranged to obtain a predetermined digital surface model from the memory storage; and determine a position and/or a pose based on the formed digital surface model and the obtained predetermined digital surface model, and/or form an updated version of the obtained predetermined digital surface model based on the formed digital surface model.

This has the advantage of allowing the formed digital surface model to be utilized to determine a position and/or a pose, wherein said determined position and/or pose may be utilized by the computer to improve a subsequent determination of treetop positions.

### BRIEF DESCRIPTION OF THE DRAWINGS

FIG. 1 shows schematically a method for forming a digital surface model of treetops.

FIG. 2a-b shows schematically neural networks trained to detect objects in images.

FIG. 3 shows schematically a system for forming a digital surface model of treetops.

FIG. 4 depicts schematically a data processing unit comprising a computer program product for forming a digital surface model of treetops.

### DETAILED DESCRIPTION

Throughout the figures, same reference numerals refer to same parts, concepts, and/or elements. Consequently, what will be said regarding a reference numeral in one figure applies equally well to the same reference numeral in other figures unless explicitly stated otherwise.

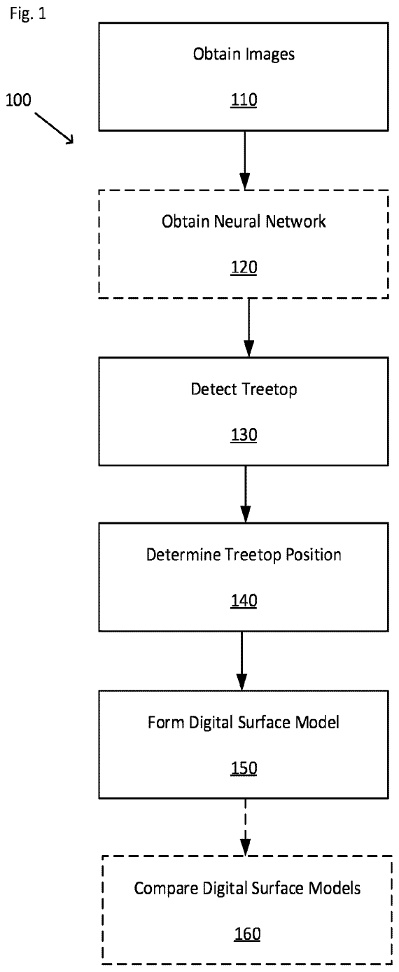

FIG. 1 shows schematically a computer implemented method 100 for forming a digital surface model of treetops. The method 100 comprises the steps of
obtaining 110 at least two images from a flying platform;
detecting 130 treetops in each image;
determining 140 a treetop position for each matching treetop detected in plurality of said at least two images; and
forming 150 the digital surface model based on said at least one determined treetop position.

The term digital surface model, DSM, relates to a 3D computer graphics representation of elevation data representing terrain. Typically said represented terrain is a part of Earth's surface.

In some examples obtaining 110 the at least two images from the flying platform comprises capturing at least two digital photos with at least one camera on said flying platform.

In some examples obtaining 110 said at least two images comprises capturing images in the visible spectrum, infrared spectrum, and/or ultraviolet spectrum.

In some examples obtaining 110 the at least two images from the flying platform comprises simultaneously capturing at least two digital photos with at least two cameras on at least said flying platform. In some of these examples obtaining 110 the at least two images from the flying platform comprises simultaneously capturing at least one digital photos from a first flying platform and at least one digital photos from a second flying platform. In some of these examples obtaining 110 the at least two images comprises obtaining a corresponding relative position and/or pose between said first flying platform and said second flying platform, and determining 140 treetop position is further based on said relative position and/or pose.

In some examples obtaining 110 at least two images from the flying platform comprises obtaining a set of relative differences between image capture positions and/or poses corresponding to said at least two images. In some of these examples determining 140 treetop position is further based on said set of relative differences between image capture positions and/or poses.

In some examples obtaining 110 at least two images from the flying platform comprises obtaining a set of relative differences between image capture poses corresponding to said at least two images. In some of these examples determining 140 treetop position is further based on said set of relative differences between image capture poses.

In some examples obtaining 110 at least two images from a flying platform further comprises obtaining an altitude measurement and determining a height of said flying platform based on said altitude measurement, and wherein determining 140 treetop position is further based on said determined height. In some of these examples said altitude measurement is a radar and/or a lidar altitude measurement.

In some examples determining 140 a treetop position for each matching treetop detected in a plurality of said at least two images comprises eliminating treetop position outliers utilizing means for outlier detection, such as random sample consensus (RANSAC) algorithms. In some of these examples the means for outlier detection utilize Euclidean distance between positions, such as L2 norm loss function, and/or utilize correlations between attributes determined for said treetop positions. The term L2 norm relates to calculating a square root of a sum of squared vector values. In some examples a distance between feature vectors for the matched detected treetops representing each determined treetop position is calculated utilizing a L2 norm loss function, thereafter a RANSAC algorithm removes determined treetop positions based on matched detected treetops and corresponding distance(s) between feature vectors. In some of these examples said RANSAC algorithm utilizes positional and geometrical criteria to detect outlier based on matched detected treetops and corresponding distance(s) between feature vectors.

In some examples forming 150 the digital surface model based on said at least one determined treetop position comprises forming a convex hull based on said at least one determined treetop position.

In some examples forming 150 the digital surface model based on said at least one determined treetop position comprises obtaining and utilizing information relating to a predetermined digital surface model and/or a predetermined digital terrain model, such as obtaining model information from a database. In some of these example forming 150 the digital surface model is further based on obtaining and utilizing information relating a set of expected heights of trees.

In some examples the method 100 further comprises obtaining 120 a neural network trained to detect treetops in images,
wherein detecting 130 treetops in each image comprises using each image as an input for said neural network, thereafter determining for each image a neural network output, and
wherein determining 140 treetop position is based on said determined neural network outputs.

In some examples the method 100 further comprises obtaining 120 a neural network trained to detect treetops in images,
wherein detecting 130 treetops in each image comprises using each image as an input for said neural network, thereafter determining for each image a neural network output, and determining for each neural network output at least one feature vector based on intermediate values generated in the neural network during treetop detection of the corresponding image, and
wherein determining 140 treetop position is based on said determined neural network outputs and corresponding at least one feature vector.

In some examples the method 100 further comprises obtaining 120 a neural network trained to detect treetops in images,
wherein detecting 130 treetops in each image comprises using each image as an input for said neural network, thereafter determining for each image a neural network output, and determining for each of at least one part of said neural network output at least one feature vector based on intermediate values generated in the neural network during treetop detection of the corresponding image, and
wherein determining 140 treetop position is based on said determined neural network outputs and corresponding at least one feature vector.

In some of these examples, said at least one part of said neural network output comprises at least one part for each detected treetop in the corresponding neural network output.

The term neural network relates to artificial neural network comprising an interconnected group of nodes, wherein said neural network is arranged to for each intermediate node (hidden node) calculate its node value as a real number based on its input(s) and provide to each node connected to its output(s) an output value calculate by some typically non-linear function. During use of a neural network each input to the neural network, such as an input image, results in a set of node values, wherein parts of the output of the neural network may correspond to a subset of said set of node values. For example, providing an input image into a neural network trained to detect treetops, wherein said neural network comprises hidden node layers arranged between an input layer and an output layer, may result in an output image indicative of a detected treetop, wherein a subset of node values in the final hidden node layer correspond to pixels in the output image that are indicative of said detected treetop. In this example the information obtained from the neural network may be both the neural network output indicative of detected treetop(s) and extracted sets of node values from the final hidden layer for each set of pixels corresponding to a detected treetop.

The term intermediate values is to be understood as any information generated in the neural network based on said input image. In an example neural network comprising an input layer of nodes, a plurality of hidden layers of nodes and an output layer, the intermediate values may, upon the neural network processing an input, be all calculated node values in the plurality of hidden layers.

The term feature vector is associated with a part of a neural network output, and is based on intermediate values generated in a neural network while producing said neural network output. In some examples the part of the neural network output for which a feature vector is determined represents a detected treetop. In some examples, wherein the neural network output comprises an output image, the part of the neural network output is a set of pixels or a set of pixels corresponding to a detected treetop. In some examples, the part of the neural network output relates to a set of coordinates of the neural network output. In some examples each part of the neural network output is a true subset of the neural network output.

Whereas the neural network output represents detected objects in the input, such as treetops, the feature vector for a part of the neural network output indicative of a treetop may be viewed as representing an underlying reason for detecting said treetop. Under the assumption that images of the same treetop captured from different poses may result in feature vectors for the same treetop that are at least partially similar, then such feature vectors may be utilized to improve detecting the same treetop in multiple images, and thereby determine a position of said treetop.

In some examples, the method 100 comprises determining for each of at least one part of said neural network output at least one feature vector based on intermediate values generated in the neural network during treetop detection of the corresponding image, wherein said intermediate values are node values comprised in a final hidden layer of said neural network. In some examples said intermediate values are node values comprised in the final and/or the penultimate hidden layers of said neural network.

In some examples detecting 130 treetops in each image comprises determining properties associated with said detected treetops, such as determined type of tree, tree growth stage or tree geometry. In some of these examples, wherein detecting 130 treetops in each image comprises using each image as an input for said neural network, said properties are determined based on the corresponding neural network output and/or the corresponding at least one feature vector. In some examples determining 140 the treetop position is further based on said determined properties associated with said detected treetops.

In some examples the intermediate values generated in the neural network during treetop detection of images corresponds to a set of values in a hidden node layer and/or values in an intermediate feature map generated in said neural network.

In some examples, obtaining 120 the neural network trained to detect treetops in images comprises obtaining a convolutional neural network. The term convolutional neural networks relate to neural networks that use convolution in place of general matrix multiplication in at least one of their layers.

In some examples, the method 100 comprises obtaining 120 a neural network trained to detect treetops in images,
detecting 130 treetops in each image comprises using each image as an input for said neural network, thereafter determining for each image a neural network output, and determining for each of at least one part of said neural network output at least one feature vector based on intermediate values generated in the neural network during treetop detection of the corresponding image, and
determining 140 treetop position based on said determined neural network outputs and corresponding at least one feature vector,
wherein determining 140 treetop position comprises calculating an Euclidian distance between determined features of said feature vectors. In some of these examples determining 140 treetop position comprises calculating the Euclidian distance based on an obtained a set of relative differences between image capture positions corresponding to said at least two images.

In some examples, determining 140 treetop position comprises comparing the feature vectors based on utilizing Euclidian distance and/or cosine similarity and/or phase correlation.

In some examples, determining 140 treetop position is further based on said at least two images obtained from the flying platform.

In some examples, the method 100 comprises forming 150 the digital surface model based on said at least one determined treetop position, wherein forming 150 the digital surface model is further based on the feature vectors associated with said at least one determined treetop position. In some of these examples tree properties associated with said at least one determined treetop position may be determined based on said feature vectors, such as type of tree, tree growth stage or tree geometry.

In some examples the method 100 further comprises comparing 160 the formed digital surface model with an obtained predetermined digital surface model, and determining a position and/or pose of said formed digital surface model based on said comparison between the formed digital surface model and the predetermined digital surface model.
In some examples the method 100 comprises comparing 160 the formed digital surface model with the obtained predetermined digital surface model, and determining a position and/or pose of the flying platform based on said comparison between the formed digital surface model and the predetermined digital surface model.

In some examples the method 100 comprises comparing 160 the formed digital surface model with the obtained predetermined digital surface model, and forming an updated version of said obtained predetermined digital surface model based on the formed digital surface model. In some of these examples forming an updated version of said obtained predetermined digital surface model is based on determined properties associated with said detected treetop positions, such as determined type of tree, tree growth stage or tree geometry, wherein said properties are determined based on the corresponding neural network output and/or the corresponding at least one feature vector.

In some examples comparing 160 the formed digital surface model with the obtained predetermined digital surface model, and forming an updated version of said obtained predetermined digital surface model based on the formed digital surface model, comprises obtaining a digital terrain model. In some of these examples, comprises obtaining the determined properties associated with said detected treetop positions, wherein the determined properties comprise type of tree and/or tree growth stage and/or tree geometry, and wherein the updated version of said obtained predetermined digital surface model comprises for each detected treetop position a determined tree height and type of tree and/or tree growth stage and/or tree geometry.

In some examples comparing 160 the formed digital surface model with the obtained predetermined digital surface model, wherein said predetermined digital surface model is a formed digital surface model based on treetop positions, comparing 160 comprises determining change in height of at least one tree. Comparing multiple formed digital surface models representing the same area may allow growth of trees to be monitored in said area.

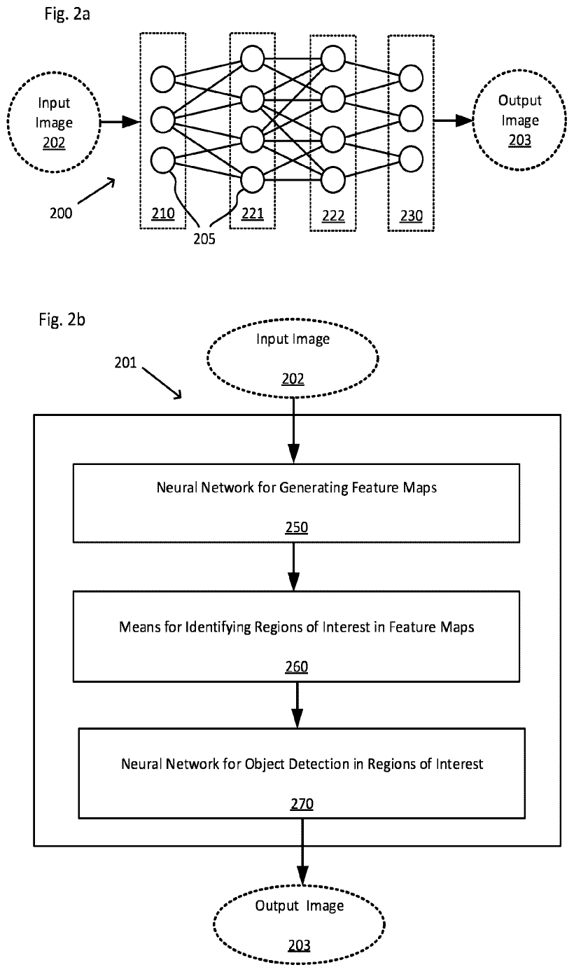

FIG. 2a-b shows schematically neural networks trained to detect objects in images. FIG. 2a schematically illustrates a simple neural network comprising an input layer, a hidden layer and an output layer. FIG. 2b depicts a neural network utilizing region of interest detection in internally generated feature maps. Neural networks for object detection, such as treetop detection, are typically performed using a computer. The example neural networks aim to illustrate examples of intermediate values generated in neural networks during use, and feature vectors associated with a detected treetop in a neural network output may be determined based on said intermediate values.

FIG. 2a shows schematically an example neural network 200 comprising an input layer 210, two hidden layers 221,222 and an output layer 230. The neural network 200 is configured to accept an input, an input image 202 in the example, and assign values to nodes 205 in the input layer 210 based on said input. In some examples a value assigned to a node 205 in the input layer 210 is based on properties of one pixel in an input image 202, such as an intensity value of said pixel. The neural network 200 is further configured to provide an output, an output image 203 in the example, based on the values in nodes 205 of the output layer 230.

In the example the output of the neural network 200 is an output image 203, the image output format is used in the example to simplify describing the relationship between the input, the output and the intermediate values of the neural network 200, such as comparing corresponding pixels in the input image 202 and the output image 203. It is to be understood that the neural network 200 may be arranged to generate output comprising information in various formats, such as a list comprising coordinates representing detected treetops with corresponding output values. The neural network 200 may be arranged to generate output in three or more dimensions, such as generating a vector of values for each pixel of a two dimensional image.

The values in nodes 205 in the hidden layers 221,222 and the output layer 230 are each calculated based on a function wherein at least one node value from a node 205 in a preceding layer is a variable, such as the resulting node values of the first hidden layer 221 being dependent on the node values of the input layer 210. In FIG. 2a nodes 205 in the first hidden layer 221 each calculate their node value based on received values from two nodes 205 in the input layer 210, thereafter the nodes 205 in the second hidden layer 222 each calculate their node value based on received node values from three nodes 205 in the first hidden layer 221, and finally the nodes 205 in the output layer 230 each calculate their node value based on received node values from two nodes 205 in the second hidden layer 222. The number of hidden layers and/or the number of nodes per layer and/or the number of connections between each node are typically larger than the schematically an example in FIG. 2a.

In some examples the neural network 200 comprises a convolutional neural network. The term convolutional neural networks relate to neural networks that use convolution in place of general matrix multiplication in at least one of their layers.

In some examples of the method described in relation to FIG. 1 detecting treetops in each image utilizing neural networks comprises determining at least one feature vector based on intermediate values generated in neural networks during use. In FIG. 2a the intermediate values correspond node values calculated for nodes 205 in the two intermediate layers 221,222 as a result of providing an input to the neural network. In some example the feature vector corresponding to a pixel of an output image is the corresponding set of node values for the nodes in the previous hidden layer 222 connected to the corresponding node in the output layer 230. In the example in FIG. 2a the feature vector for a pixel in an output image 203 comprises the node values of the two nodes 205 in the hidden node layer 222 connected to the node 205 in the output layer 230 corresponding to said pixel. In some examples a plurality of pixels in an output image 203 represents one detected treetop, whereby a plurality of feature vectors corresponds to said detected treetop.

It is to be understood that a plurality of feature vectors may be represented by one aggregate feature vector.

FIG. 2b shows schematically an example neural network 201 for detecting objects configured to accept an input, such as an input image 202, and provide an output in the format of an output image 203, wherein said output image 203 is indicative of objects detected in the input image 202. The neural network 201 comprises a first neural network 250 configured to generate at least one feature map based on the input; means 260 for identifying regions of interest in said generated feature map, wherein the region of interest is selected based on the object types being detected; and a second neural network 270 configured to detect said object types in regions of interest of feature maps and generate an output indicative of any detected objects, being the output image 203.

The neural network 201 in FIG. 2b may be viewed as the neural network 200 in FIG. 2a with the hidden layers 221,222 split into two parts, wherein the means 260 for identifying regions of interest provides parts of the output of the first part of the hidden layer to the start of the second part of the hidden layer.

In an example aiming to relate the parts of the neural network 201 to treetop detection, the first neural network 250 generates feature maps for features associated with trees, the means 260 for identifying regions of interest forms regions of interest based on said feature maps that are expected to contain a tree, and the second neural network 270 detects treetops in each formed region of interest expected to contain a tree.

In some examples the first neural network 250 and/or the second neural network 270 comprises a convolutional neural network.

In some examples of the method described in relation to FIG. 1 detecting treetops in each image utilizing neural networks comprises determining at least one feature vector based on intermediate values generated in neural networks during use. In FIG. 2b the intermediate values generated in neural networks when an output is calculated for an input may correspond to generated feature maps, and/or the parts of generated feature maps in an identified region of interest, and/or node values calculated for nodes of hidden layers of the first 250 and/or the second neural network 270. In some examples a plurality of pixels in an output image 203 represents one detected treetop, wherein a plurality of feature vectors based on said generated feature maps and/or parts of generated feature maps in an identified region of interest corresponds to said detected treetop.

Some examples of the method described in relation to FIG. 1 comprises determining a treetop position for each treetop detected in plurality images, wherein matching images is based on neural network output images 203 and corresponding feature vectors. Neural networks trained to detect treetops, such as the example neural networks in FIG. 2a-b, may be utilized to generate output images 203 and corresponding feature vectors for a plurality of input images 202, and detecting tree tops present in at least two images based on comparing said output images 203 and feature vectors.

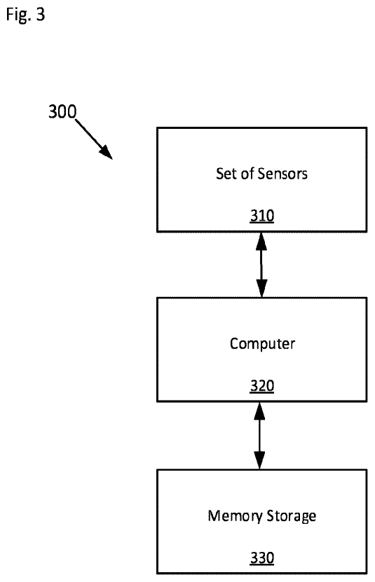

FIG. 3 shows schematically a system for forming a digital surface model of treetops. The system 300 comprises a set of sensors 310, a computer 320 and a memory storage 330, wherein the computer 320 is connected to and configured to control the set of sensors 310 and the memory storage 330. The set of sensors 310 is arranged to capture images from a flying platform.

In some examples of the system 300, the computer 320 is arranged to
obtain at least two images from the set of sensors 310;
detect treetops in each image;
determine a treetop position for each matching treetop detected in plurality of said at least two images; and
form a digital surface model based on said at least one determined treetop position and store said digital surface model on the memory storage 330.

In some examples the set of sensors 310 comprises a digital camera. In some of these examples the set of sensors 310 comprises a radar, a lidar, and/or means to control and determined an orientation of said digital camera, such as an actuated camera mount.

It is to be understood that at least part of the set of sensors 310 provide the at least two images, and part of the set of sensors 310 may provide auxiliary information useful for determining a position of detected treetops in a georeferences coordinate system. For example a radar or a lidar may provide altitude measurement data for the flying platform.

In some examples the memory storage 330 comprises a predetermined digital surface model of a part of Earth's surface.

In some examples the computer 320 is arranged to detect and eliminate treetop position outliers. In some of these examples the computer 320 utilizes random sample consensus (RANSAC) algorithms, and/or correlations between attributes determined for said treetop positions to detect treetop position outliers. In some of these examples the computer 320 determines Euclidean distance between feature vectors of matched treetops, such as utilizing a L2 norm loss function, wherein detection and elimination of treetop position outliers is based on said determined distance between feature vectors.

In some examples the computer 320 is arranged to
detect treetops in each image using a neural network trained to detect treetops in images, determine for each image a neural network output, and determine for at least one part of said neural network output a feature vector based on intermediate values generated in the neural network during treetop detection of the corresponding image; and
determine treetop position based on said determined neural network outputs and corresponding at least one feature vector.

In some examples, the computer 320 is arranged to determine treetop position by comparing the feature vectors utilizing Euclidian distance and/or cosine similarity and/or phase correlation.

In some examples said neural network comprises a convolutional neural network.

In some of these examples the computer 320 is arranged to obtain at least part of the predetermined digital surface model of a part of Earth's surface from memory storage 330, and form an updated digital surface model based on combining the predetermined digital surface model and said formed digital surface model based on said at least one determined treetop position.

In some examples the computer 320 is arranged to
obtain at least two images from the set of sensors 310;
detect treetops in each image;
determine a treetop position for each matching treetop detected in plurality of said at least two images;
form a digital surface model based on said at least one determined treetop position,
obtain at least part of the predetermined digital surface model of a part of Earth's surface from memory storage 330, and
determine a position and/or pose of the flying aircraft based on comparing said predetermined digital surface model and said formed digital surface model based on said at least one determined treetop position.

In some examples the computer 320 is further arranged to obtain a set of relative differences in image capture position corresponding to said at least two images, and is arranged to determine treetop position based on said set of relative differences in image capture position. In some of these examples the set of sensors 310 is arranged to determine the set of relative differences in image capture position corresponding to said at least two images.

In some examples the computer 320 is further arranged to obtain a set of relative differences in image capture pose corresponding to said at least two images, and is arranged to determine treetop position based on said set of relative differences in image capture position. In some of these examples the set of sensors 310 is arranged to determine the set of relative differences in image capture pose corresponding to said at least two images.

In some examples the computer 320 is further arranged to obtain an altitude measurements and determining a height of said flying platform based on said altitude measurements, and wherein determining treetop position is further based on said determined height. In some of these examples the set of sensors 310 is arranged to perform radar and/or lidar altitude measurements.

In some examples the set of sensors 310 is arranged to provide navigation information of the flying platform.

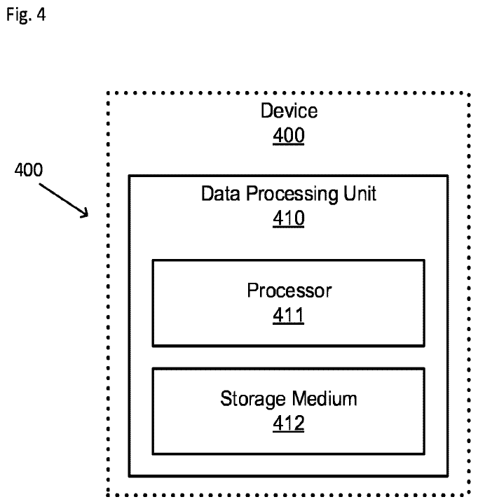

FIG. 4 depicts schematically a data processing unit comprising a computer program product for forming a digital surface model of treetops. FIG. 4 depicts a data processing unit 410 comprising a computer program product comprising a non transitory computer-readable storage medium 412. The non-transitory computer-readable storage medium 412 having thereon a computer program comprising program instructions. The computer program is loadable into a data processing unit 410 and is configured to cause a processor 411 to carry out the method for forming a digital surface model of treetops.

In some examples the data processing unit 410 is comprised in a device 400.

In some examples the data processing unit 410 is comprised in the computer 320 described in FIG. 3.

Returning to FIG. 3 and FIG. 2a, an example scenario of using a system 300 for forming a digital surface model of treetops will be described.

The example system 300 comprises a set of sensors 310, a computer 320 and a memory storage 330, wherein the computer 320 is connected to and configured to control the set of sensors 310 and the memory storage 330. The set of sensors is arranged to capture images from a flying platform.

The computer 320 is arranged to
obtain at least two images from the set of sensors 310;
detect treetops in each image;
determine a treetop position for each matching treetop detected in plurality of said at least two images; and
form a digital surface model based on said at least one determined treetop position,
store formed digital surface models in the memory storage 330,
wherein detecting treetops in each image comprises utilizing a neural network 200 trained to detect treetops in images, determining for each image a neural network output, and determining for at least one part of said neural network output a feature vector based on intermediate values generated in the neural network during treetop detection of the corresponding image; and
wherein determining treetop position is based on said determined neural network outputs and corresponding at least one feature vector.

In the example scenario, the example system 300 is comprised in an unmanned aerial vehicle, UAV. In the example scenario the UAV is on a mission to travel over an area, and repeatedly capturing images to form a digital surface digital surface model of treetops. The memory storage 330 comprises a predetermined digital surface model, DSM, representing the area the UAV is travelling over. The system 300 is arranged to determine the UAV position and/or pose based on comparing formed digital surface digital surface models with said predetermined DSM.

The set of sensors 310 comprises one digital camera, and rudimentary navigation means arranged to provide navigation information of the UAV. Said rudimentary navigation means comprises means to provide bearing and means to monitor the UAV propulsion and estimate UAV speed.

In the example scenario the UAV is flying forward above a terrain comprising trees. The system 300 captures a first image of the terrain with the set of sensors 310. The UAV moves forward and the system 300 captures a second image of the terrain with the set of sensors 310. In the example scenario the height of the UAV, the digital camera angle towards the terrain and the distance moved between capturing images is such that there is a significant overlap between the two images, and the terrain corresponding to said overlap contains trees.

The computer 320 obtains said two captured images from the set of sensors 310, and each image is used as input for the neural network 200 to generate an output image 203. In the example scenario the feature vectors are based on node values 205 of a final hidden layer 222 of the neural network 200, and for each detected treetop a feature vector is determined.

In the example scenario the first image results in a first output image 203 and its corresponding feature vectors, and independently the second image results in a second output image 203 and its corresponding feature vectors.

In the example scenario the computer 320 obtains navigation information for the duration in which the first image and the second image where captured. At least part of the navigation information is provided by the rudimentary navigation means comprised in the set of sensors 310, wherein provided navigation information comprises bearing, UAV propulsion data and estimated UAV speed. Based on said navigation information the computer 320 calculates a set of constraints to the relative position and/or pose difference between the first image and the second image. Even partial information relating to the relative position and/or pose difference between the first image and the second image may be utilized in order to decrease the degrees of freedom and thereby decrease computational load when determining treetop positions.

The computer 320 determines treetop positions for any matching detected treetops in both the first and second output images 203 based on feature vectors. A pair of detected treetops may be determined to match based on similarities in their surrounding in said output images 203 and/or feature vectors. In the example scenario matching treetop pairs are determined based on the relative position of any surrounding detected treetops in the output images 203 and based on matching properties of their the feature vectors. In the example scenario the computer 320 utilizes the calculated set of constraints to the relative position and/or pose difference between the first image and the second image to determine treetop positions and to decrease the computational load of determining said treetop positions.

The computer 320 evaluates the determined treetop positions and removes any treetop positions determined to be outliers. In the example scenario the computer 320 removes treetop positions located anomalously high or low compared to surrounding treetop positions.

The computer 320 forms the digital surface model based on the determined treetop positions. In the example scenario the computer 320 stores the formed the digital surface model on the memory storage 330. As the UAV travels over the terrain the system 300 repeatedly captures images of the terrain and the computer 320 forms digital surface models based on the determined treetop positions.

After the UAV has captured and processed a plurality of images, the computer 320 obtains said predetermined DSM representing the terrain in the area and at least one stored formed digital surface model from the memory storage 330. The computer 320 determines a position and/or a pose of the UAV based on comparing said predetermined and formed digital surface models. Said determined position and/or pose is stored as navigation information on the memory storage 330 and said navigation information is utilized the next time the computer 320 determines treetop positions or compares digital surface models.

1. A computer implemented method for forming a digital surface model of treetops, the method (100) comprises the steps of:
obtaining (110) at least two images from a flying platform;
detecting (130) treetops in each image;
determining (140) a treetop position for each matching treetop detected in plurality of said at least two images; and
forming (150) the digital surface model based on said at least one determined treetop position.

2. The method according to claim 1, further comprising:
obtaining (120) a neural network (200,201) trained to detect treetops in images, wherein;
detecting (130) treetops in each image comprises utilizing each image as an input image (202) for said neural network (200,201), determining for each image a neural network output, and, if said output comprises at least one detected treetop, determining for each detected treetop a feature vector based on intermediate values calculated in the neural network (200,201) while generating said output; and
determining (140) the treetop position is based on said determined neural network outputs and corresponding at least one feature vector.

3. The method according to claim 2, wherein:
determining (140) the treetop position comprises comparing feature vectors corresponding to said determined neural network outputs, and
determining (140) the treetop position is based on matching neural network outputs based on said comparison of feature vectors.

4. The method according to claim 3, wherein comparing the feature vectors is based on utilizing Euclidian distance, and/or cosine similarity, and/or scalar product, and/or phase correlation.

5. The method according to claim 1, wherein obtaining (110) said at least two images comprises capturing images in the visible spectrum, infrared spectrum, and/or ultraviolet spectrum.

6. The method according to claim 1, any wherein obtaining (110) at least two images from a flying platform further comprises obtaining a set of relative differences in image capture position and/or pose corresponding to said at least two images, and wherein determining (140) treetop position is further based on said set of relative differences in image capture position and/or pose.

7. The method according to claim 1, wherein obtaining (110) at least two images from a flying platform further comprises obtaining a radar and/or a lidar altitude measurement and determining a height of said flying platform based on said altitude measurement, and wherein determining (140) treetop position is further based on said determined height.

8. The method according to claim 1, wherein determining (140) the treetop position for each matching treetop detected in a plurality of said at least two images comprises detecting and eliminating treetop position outliers.

9. The method according to claim 1, further comprising:
comparing (160) the formed digital surface model with an obtained predetermined digital surface model, and
determining a position and/or a pose of the flying platform based on said comparison between the formed digital surface model and the predetermined digital surface model, and/or forming an updated version of said obtained predetermined digital surface model based on the formed digital surface model.

10. A computer program product comprising a non-transitory computer-readable storage medium (412) having thereon a computer program comprising program instructions, the computer program being loadable into a processor (411) and configured to cause the processor (411) to perform the method (100) for forming a digital surface model of treetops according to claim 1.

11. A system for forming a digital surface model of treetops, the system (300) comprising:
a set of sensors (310) arranged to capture images, and
a computer (320) configured to communicate with the set of sensors (310),
wherein the computer (320) is further configured to:
obtain at least two images from the set of sensors (310);
detect treetops in each image;
determine a treetop position for each matching treetop detected in a plurality of said at least two images; and
form the digital surface model based on said at least one determined treetop position.

12. The system according to claim 11, wherein the computer (320) is further configured to:
detect treetops in each image using a neural network (200,201) trained to detect treetops in images, determine for each image a neural network output, and determine for each of at least one part of said neural network output a feature vector based on intermediate values generated in the neural network (200,201) during treetop detection of the corresponding image; and
determine treetop position based on said determined neural network outputs and corresponding at least one feature vector.

13. The system according to claim 11, further comprising:
a memory storage (330) comprising at least one predetermined digital surface model, wherein the computer (320) is configured to communicate with the memory storage (330), and
wherein the computer (320) is further configured to:
obtain a predetermined digital surface model from the memory storage (330); and
determine a position and/or a pose based on the formed digital surface model and the obtained predetermined digital surface model, and/or form an updated version of the obtained predetermined digital surface model based on the formed digital surface model.

14. The system according to claim 12, further comprising:
a memory storage (330) comprising at least one predetermined digital surface model, wherein the computer (320) is configured to communicate with the memory storage (330), and wherein the computer (320) is further configured to:
obtain a predetermined digital surface model from the memory storage (330); and
determine a position and/or a pose based on the formed digital surface model and the obtained predetermined digital surface model, and/or form an updated version of the obtained predetermined digital surface model based on the formed digital surface model.
